(19) United States
(12) Patent Application Publication
(10) Pub. No.: US 2015/0325040 A1
(43) Pub. Date: Nov. 12, 2015

(54) METHOD, APPARATUS AND COMPUTER PROGRAM PRODUCT FOR IMAGE RENDERING

(71) Applicant: NOKIA CORPORATION, Espoo (FI)

(72) Inventor: Vlad Alexandru Stirbu, Tampere (FI)

(21) Appl. No.: 14/652,216

(22) PCT Filed: Dec. 27, 2012
(86) PCT No.: PCT/FI2012/051296

§ 371 Date: Jun. 15, 2015

(51) Int. Cl. G06T 15/40

(52) U.S. Cl. CPC G06T 15/40

(57) ABSTRACT

In accordance with an example embodiment a method, apparatus and computer program product are provided. The method comprises receiving a request for inclusion of a first object in a scene comprising one or more second objects. The scene is rendered based on a scene geometry data. At least one second object from the one or more second objects occluded by a portion of the first object is determined based on the scene geometry data. The at least one second object being occluded by the portion of the first object in the scene are re-rendered based on the determination. The re-rendering facilitates in preventing occlusion of the at least one second object by the portion of the first object.

### TECHNICAL FIELD

Various implementations relate generally to method, apparatus, and computer program product for image rendering.

### BACKGROUND

The rapid advancement in technology related to capturing and rendering images has resulted in an exponential increase in the creation of multimedia content. Devices like mobile phones and personal digital assistants (PDA) are now being increasingly configured with image capturing tools, such as a camera, thereby facilitating easy capture of the image content. The captured images may be subjected to processing based on various user needs. For example, the captured images may be processed such that objects in the images may be rendered in three-dimension (3D) computer graphics. In certain applications, while rendering the 3D objects, hidden surfaces may be removed that may occur/appear behind other objects. The process of removing hidden surfaces may be termed as object occlusion or visibility occlusion.

### SUMMARY OF SOME EMBODIMENTS

Various aspects of example embodiments are set out in the claims.

In a first aspect, there is provided a method comprising: receiving a request for inclusion of a first object in a scene comprising one or more second objects; rendering the scene based on a scene geometry data; determining at least one second object of the one or more second objects in the scene being occluded by a portion of the first object based on the scene geometry data; and re-rendering the at least one second object being occluded by the portion of the first object in the scene based on the determination, the re-rendering facilitating in preventing occlusion of the at least one second object by the portion of the first object.

In a second aspect, there is provided an apparatus comprising at least one processor; and at least one memory comprising computer program code, the at least one memory and the computer program code configured to, with the at least one processor, cause the apparatus to at least perform: receive a request for inclusion of a first object in a scene comprising a one or more second objects; generate the scene based on a spatial information associated with the scene; render the scene based on a scene geometry data, the scene geometry data being generated based on the scene information; determine at least one second object of the one or more second object in the scene being occluded by a portion of the first object based on the scene geometry data; and re-render the at least one second object being occluded by the portion of the first object in the scene based on the determination, the re-rendering facilitating in preventing occlusion of the at least one second object by the portion of the first object.

In a third aspect, there is provided an apparatus comprising at least one processor; and at least one memory comprising computer program code, the at least one memory and the computer program code configured to, with the at least one processor, cause the apparatus to at least perform: receive a spatial information associated with a scene, the scene comprising one or more second objects; and generate a scene geometry data based on the spatial information, the scene geometry data configured to facilitate in determination of at least one second object of the one or more second objects in the scene being occluded by a portion of a first object included into the scene.

In a fourth aspect, there is provided a computer program product comprising at least one computer-readable storage medium, the computer-readable storage medium comprising a set of instructions, which, when executed by one or more processors, cause an apparatus to at least perform: receive a request for inclusion of a first object in a scene comprising one or more second objects; render the scene based on a scene geometry data; determine at least one second object of the one or more second objects in the scene being occluded by a portion of the first object based on the scene geometry data; and re-render the at least one second object being occluded by the portion of the first object in the scene based on the determination, the re-rendering facilitating in preventing occlusion of the at least one second object by the portion of the first object.

In a fifth aspect, there is provided a computer program product comprising at least one computer-readable storage medium, the computer-readable storage medium comprising a set of instructions, which, when executed by one or more processors, cause an apparatus to at least perform: receive a spatial information associated with a scene comprising one or more second objects; and generate a scene geometry data based on the spatial information, the scene geometry data configured to facilitate in determination of at least one second object in the scene being occluded by a portion of a first object included into the scene.

In a sixth aspect, there is provided an apparatus comprising: means for receiving a request for inclusion of a first object in a scene comprising one or more second objects; means for rendering the scene based on a scene geometry data; means for determining at least one second object of the one or more second objects in the scene being occluded by a portion of the first object based on a scene geometry data; and means for re-rendering the at least one second object being occluded by a portion of the first object in the scene based on the determination, the re-rendering facilitating in preventing occlusion of the at least one second object by the portion of the first object.

In a seventh aspect, there is provided an apparatus comprising: means for receiving a spatial information associated with a scene comprising one or more second objects; and means for generating a scene geometry data based on the spatial information, the scene geometry data configured to facilitate in determination of at least one second object of the one or more second objects being occluded by a portion of a first object included into the scene.

In an eighth aspect, there is provided a computer program comprising program instructions which when executed by an apparatus, cause the apparatus to: receive a spatial information associated with a scene comprising one or more second objects; and generate a scene geometry data based on the spatial information, the scene geometry data configured to facilitate in determination of at least one second object of the one or more second objects being occluded by a portion of a first object included into the scene.

In an ninth aspect, a computer program comprising program instructions which when executed by an apparatus, cause the apparatus to: receive a request for inclusion of a first object in a scene comprising one or more second objects; render the scene based on a scene geometry data; determine at least one second object of the one or more second objects in the scene being occluded by a portion of the first object based on a scene geometry data; and re-render the at least one second object being occluded by a portion of the first object in the scene based on the determination, the re-rendering facilitating in preventing occlusion of the at least one second object by the portion of the first object.

### BRIEF DESCRIPTION OF THE FIGURES

Various embodiments are illustrated by way of example, and not by way of limitation, in the figures of the accompanying drawings in which:

FIG. 1 illustrates an system for image rendering in accordance with an example embodiment;

FIG. 2 illustrates a device in accordance with an example embodiment;

FIG. 3 illustrates an apparatus for image rendering in accordance with an example embodiment;

FIGS. 4A and 4B represent an example scene geometry and an example scene geometry data associated with a scene, in accordance with an example embodiment;

FIG. 5 illustrate a flowchart depicting an example method for image rendering in accordance with an example embodiment;

FIG. 6 illustrate a flowchart depicting another example method for image rendering in accordance with an example embodiment; and

FIGS. 7A, 7B, 7C and 7D illustrate an example for rendering of an image, in accordance with an example embodiment.

### DETAILED DESCRIPTION

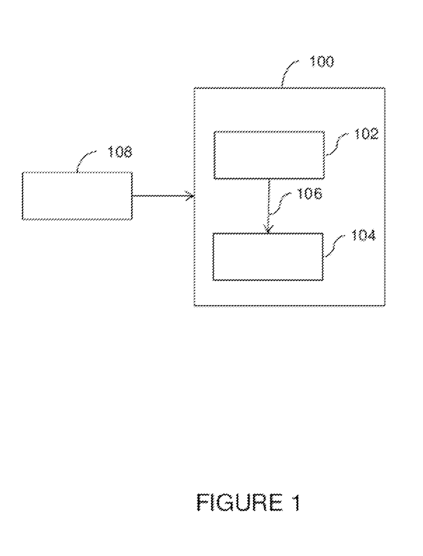

Example embodiments and their potential effects are understood by referring to FIGS. 1 through 7D of the drawings.

FIG. 1 illustrates an exemplary system 100 for performing image rendering in accordance with an example embodiment. In an example embodiment, the system 100 may be configured to render images of a scene based on an occlusion culling on objects inserted into the scene, for example virtual objects. In an example, the term ‘occlusion culling’ may refer to a process of identifying and rendering only those portions of three dimensional (3-D) images in a scene that may be visible, for example, from a user location. Some objects may not be visible in a scene due to being obscured by objects inserted in the scene. In an embodiment, occlusion culling facilitates in reducing the processing time and processing required for rendering the 3-D image of the scene. In an embodiment, a portion of the virtual object inserted into the 3-D scene may not be rendered in the image since the portion may be obscured due to the presence of other objects in the scene that appear closer as compared to the virtual object when observed/seen from a reference location.

In an embodiment, the system 100 is configured to facilitate insertion of the virtual objects into the 3-D image of the scene. The virtual objects are inserted in a manner that the visibility of a first object, for example the virtual object from a reference location (point of view) is determined based on the presence of one or more second objects of the scene which are closer to reference location relative to the location of the virtual object. As illustrated, the system 100 includes a server 102, for example, a data processing server, and at least one client 104. In an embodiment, the server 102 is configured to prepare a data obtained from a geospatial data server to a format that is suitable to be visualized in a client, for example, the client 104. In an embodiment, the data provided by the server 102 comprises a scene geometry data. The scene geometry data associated with a scene may include a projected panorama image of the scene captured by the geospatial server. In an embodiment, the panorama image may be utilized as a background portion of the scene to be rendered. In an embodiment, the scene geometry data may further include a set of masks that correspond to image objects, a set of points-of-interest (POI) placements relative to the objects, such as buildings and terrain associated with the scene. The mask associated with an image of an object may refer an image that may be overlaid on a target image (the image that is to be rendered) such that the underlying object may be seen through the mask.

In an embodiment, the server 102 may be any kind of equipment that is able to communicate with the at least one client. Accordingly, in an embodiment, a device, such as a communication device (for example, a mobile phone) may comprise or include a server connected to the Internet. In another embodiment, the server may be an apparatus or a software module that may be configured in the same device as the client, and communicates with the client by means of a communication path, for example a communication path 106. In an embodiment, the communication path linking the at least one client, for example, the client 104 and the server 102 may include a radio link access network of a wireless communication network. Examples of wireless communication network may include, but are not limited to a cellular communication network. The communication path may additionally include other elements of a wireless communication network and even elements of a wireline communication network to which the wireless communication network is coupled.

In an embodiment, the server 102 is configured to receive a spatial data (for example, the geo-spatial data) associated with the scene, and transform the spatial data into the scene geometry data. In an embodiment, the server 102 may receive the spatial data from a geo-spatial server, for example a server 108. In an example embodiment, the spatial data associated with a scene may include a real-time 3-D representation of the various buildings and other objects associated with a location represented by the scene. In an embodiment, the server 108 may include a geo-spatial database for storing the geo-spatial data. In an embodiment, the spatial data may be available over a wide range of communication network, for example, the Internet. In an embodiment, the server 108 may be a data collecting and data-storing server. For example, the server 108 may be configured to capture images associated with a scene of a real-world location. The captured images may include geographic features, traffic information, terrain information, and the like. Examples of geo-spatial server may include, but are not limited to, a NAVTEQ server.

The client 104 may be operated by a user. In an embodiment, the client 104 may be a web-browser that may be configured to be implemented in a client terminal. Examples of a client terminal may include an electronic device. In an embodiment, the electronic device may include communication device, media capturing device with communication capabilities, computing devices, and the like. Some examples of the communication device may include a mobile phone, a personal digital assistant (PDA), and the like. Some examples of computing device may include a laptop, a personal computer, and the like. In an example embodiment, the electronic device may include a user interface, having user interface circuitry and user interface software configured to facilitate a user to control at least one function of the electronic device through use of a display and further configured to respond to user inputs. In an example embodiment, the electronic device may include a display circuitry configured to display at least a portion of the user interface of the electronic device. The display and display circuitry may be configured to facilitate the user to control at least one function of the electronic device. In an embodiment, the display circuitry may facilitate in rendering of the scene geometry on the client terminal.

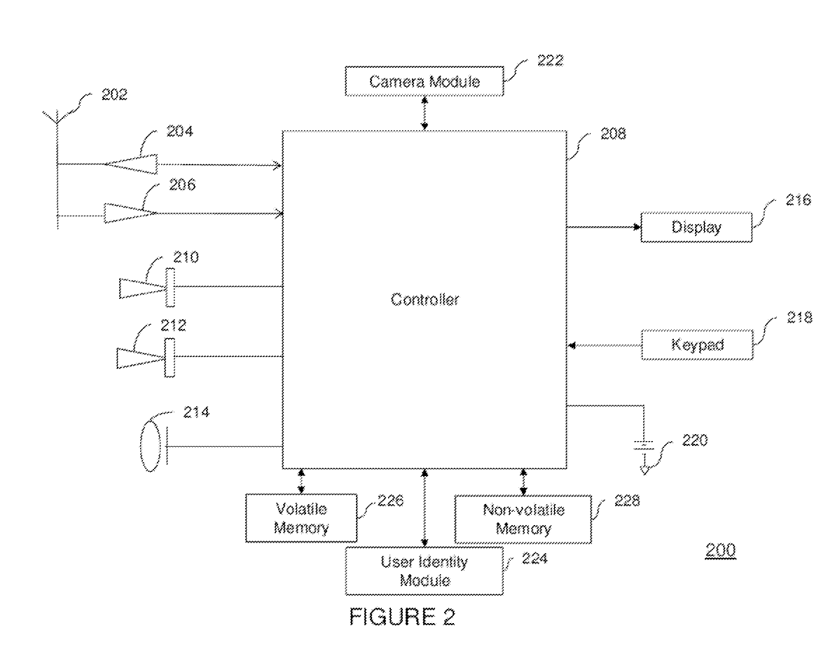

In an embodiment, the server 102, the serve 108 and the client 104 may be referred to as nodes, connected via a network. The connection between the nodes may be any electronic connection such as an Internet, intranet, telephone lines, and the like. In an embodiment, the nodes may be linked by a wireline connection or a wireless connection. Examples of the wireless connection may include but are not limited to a radio wave communication and a laser communication. In an embodiment, one node may be configured to assume a plurality of roles/functionalities at a time. For example, a node may serve as the server 102 and client 104 at the same time. In another embodiment, the server 102 and the client 104 may be configured in different nodes, and accordingly may serve different functionalities at the same time. Various embodiments are herein disclosed further in conjunction with FIGS. 2 to 7D.

FIG. 2 illustrates a device 200 in accordance with an example embodiment. It should be understood, however, that the device 200 as illustrated and hereinafter described is merely illustrative of one type of device that may benefit from various embodiments, therefore, should not be taken to limit the scope of the embodiments. As such, it should be appreciated that at least some of the components described below in connection with the device 200 may be optional and thus in an example embodiment may include more, less or different components than those described in connection with the example embodiment of FIG. 2. The device 200 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 200 may include an antenna 202 (or multiple antennas) in operable communication with a transmitter 204 and a receiver 206. The device 200 may further include an apparatus, such as a controller 208 or other processing device that provides signals to and receives signals from the transmitter 204 and receiver 206, respectively. The signals may include signaling information in accordance with the air interface standard of the applicable cellular system, and/or may also include data corresponding to user speech, received data and/or user generated data. In this regard, the device 200 may be capable of operating with one or more air interface standards, communication protocols, modulation types, and access types. By way of illustration, the device 200 may be capable of operating in accordance with any of a number of first, second, third and/or fourth-generation communication protocols or the like. For example, the device 200 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 200 may be capable of operating in accordance with non-cellular communication mechanisms. For example, computer networks such as the Internet, local area network, wide area networks, and the like; short range wireless communication networks such as Bluetooth® networks, Zigbee® networks, Institute of Electric and Electronic Engineers (IEEE) 802.11x networks, and the like; wireline telecommunication networks such as public switched telephone network (PSTN).

The controller 208 may include circuitry implementing, among others, audio and logic functions of the device 200. For example, the controller 208 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 200 are allocated between these devices according to their respective capabilities. The controller 208 thus may also include the functionality to convolutionally encode and interleave message and data prior to modulation and transmission. The controller 208 may additionally include an internal voice coder, and may include an internal data modem. Further, the controller 208 may include functionality to operate one or more software programs, which may be stored in a memory. For example, the controller 208 may be capable of operating a connectivity program, such as a conventional Web browser. The connectivity program may then allow the device 200 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 200 may also comprise a user interface including an output device such as a ringer 210, an earphone or speaker 212, a microphone 214, a display 216, and a user input interface, which may be coupled to the controller 208. The user input interface, which allows the device 200 to receive data, may include any of a number of devices allowing the device 200 to receive data, such as a keypad 218, a touch display, a microphone or other input device. In embodiments including the keypad 218, the keypad 218 may include numeric (0-9) and related keys (#, *), and other hard and soft keys used for operating the device 200. Alternatively or additionally, the keypad 218 may include a conventional QWERTY keypad arrangement. The keypad 218 may also include various soft keys with associated functions. In addition, or alternatively, the device 200 may include an interface device such as a joystick or other user input interface. The device 200 further includes a battery 220, such as a vibrating battery pack, for powering various circuits that are used to operate the device 200, as well as optionally providing mechanical vibration as a detectable output.

In an example embodiment, the device 200 includes a media capturing element, such as a camera, video and/or audio module, in communication with the controller 108. The media capturing element may be any means for capturing an image, video and/or audio for storage, display or transmission. In an example embodiment, the media capturing element is a camera module 222 which may include a digital camera capable of forming a digital image file from a captured image. As such, the camera module 222 includes all hardware, such as a lens or other optical component(s), and software for creating a digital image file from a captured image. Alternatively, or additionally, the camera module 222 may include the hardware needed to view an image, while a memory device of the device 100 stores instructions for execution by the controller 208 in the form of software to create a digital image file from a captured image. In an example embodiment, the camera module 222 may further include a processing element such as a co-processor, which assists the controller 208 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 222 may provide live image data to the display 216. In an example embodiment, the display 216 may be located on one side of the device 200 and the camera module 222 may include a lens positioned on the opposite side of the device 200 with respect to the display 216 to enable the camera module 222 to capture images on one side of the device 200 and present a view of such images to the user positioned on the other side of the device 200.

The device 200 may further include a user identity module (UIM) 224. The UIM 224 may be a memory device having a processor built in. The UIM 224 may include, for example, a subscriber identity module (SIM), a universal integrated circuit card (UICC), a universal subscriber identity module (USIM), a removable user identity module (R-UIM), or any other smart card. The UIM 224 typically stores information elements related to a mobile subscriber. In addition to the UIM 224, the device 200 may be equipped with memory. For example, the device 200 may include volatile memory 226, such as volatile random access memory (RAM) including a cache area for the temporary storage of data. The device 200 may also include other non-volatile memory 228, which may be embedded and/or may be removable. The non-volatile memory 228 may additionally or alternatively comprise an electrically erasable programmable read only memory (EEPROM), flash memory, hard drive, or the like. The memories may store any number of pieces of information, and data, used by the device 200 to implement the functions of the device 200.

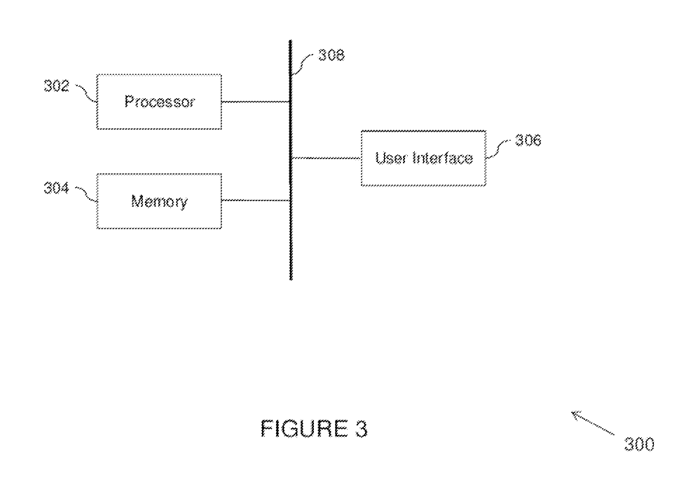

FIG. 3 illustrates an apparatus 300 for image rendering, in accordance with an example embodiment. The apparatus 300 for image rendering may be employed, for example, in the device 200 of FIG. 2. However, it should be noted that the apparatus 300, may also be employed on a variety of other devices both mobile and fixed, and therefore, embodiments should not be limited to application on devices such as the device 200 of FIG. 2. Alternatively, embodiments may be employed on a combination of devices including, for example, those listed above. Various embodiments may be embodied wholly at a single device, (for example, the device 200). It should also be noted that some of the devices or elements described below may not be mandatory and thus some may be omitted in certain embodiments.

In an embodiment, for performing image rendering, the images and associated data for rendering of images may be provided by a server, for example a server 108 described with reference to FIG. 1, and stored in the memory of the device 200. In an embodiment, the images may correspond to a scene. The images may be stored in the internal memory such as hard drive, of the apparatus 300 or in external storage medium such as digital versatile disk, compact disk, flash drive, memory card, or from external storage locations through Internet, Bluetooth®, and the like.

The apparatus 300 includes or otherwise is in communication with at least one processor 302 and at least one memory 304. Examples of the at least one memory 304 include, but are not limited to, volatile and/or non-volatile memories. Some examples of the volatile memory include, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 304 may be configured to store information, data, applications, instructions or the like for enabling the apparatus 200 to carry out various functions in accordance with various example embodiments. For example, the memory 304 may be configured to buffer input data comprising multimedia content for processing by the processor 302. Additionally or alternatively, the memory 304 may be configured to store instructions for execution by the processor 302.

An example of the processor 302 may include the controller 308. The processor 302 may be embodied in a number of different ways. The processor 302 may be embodied as a multi-core processor, a single core processor; or combination of multi-core processors and single core processors. For example, the processor 302 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 304 or otherwise accessible to the processor 302. Alternatively or additionally, the processor 302 may be configured to execute hard coded functionality. As such, whether configured by hardware or software methods, or by a combination thereof, the processor 302 may represent an entity, for example, physically embodied in circuitry, capable of performing operations according to various embodiments while configured accordingly. For example, if the processor 302 is embodied as two or more of an ASIC, FPGA or the like, the processor 302 may be specifically configured hardware for conducting the operations described herein. Alternatively, as another example, if the processor 302 is embodied as an executor of software instructions, the instructions may specifically configure the processor 302 to perform the algorithms and/or operations described herein when the instructions are executed. However, in some cases, the processor 302 may be a processor of a specific device, for example, a mobile terminal or network device adapted for employing embodiments by further configuration of the processor 302 by instructions for performing the algorithms and/or operations described herein. The processor 302 may include, among other things, a clock, an arithmetic logic unit (ALU) and logic gates configured to support operation of the processor 302.

A user interface 306 may be in communication with the processor 302. Examples of the user interface 306 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 306 may include, among other devices or elements, any or all of a speaker, a microphone, a display, and a keyboard, touch screen, or the like. In this regard, for example, the processor 302 may comprise user interface circuitry configured to control at least some functions of one or more elements of the user interface 306, such as, for example, a speaker, ringer, microphone, display, and/or the like. The processor 302 and/or user interface circuitry comprising the processor 302 may be configured to control one or more functions of one or more elements of the user interface 306 through computer program instructions, for example, software and/or firmware, stored on a memory, for example, the at least one memory 304, and/or the like, accessible to the processor 302.

In an example embodiment, the apparatus 300 may include an electronic device. Some examples of the electronic device include communication device, media capturing device, media capturing device with communication capabilities, computing devices, and the like. Some examples of the communication device may include a mobile phone, a personal digital assistant (PDA), and the like. Some examples of computing device may include a laptop, a personal computer, and the like. In an example embodiment, the electronic device may include a user interface, for example, the UI 206, having user interface circuitry and user interface software configured to facilitate a user to control at least one function of the electronic device through use of a display and further configured to respond to user inputs. In an example embodiment, the electronic device may include a display circuitry configured to display at least a portion of the user interface of the electronic device. The display and display circuitry may be configured to facilitate the user to control at least one function of the electronic device.

In an example embodiment, the electronic device may be embodied as to include a transceiver. The transceiver may be any device operating or circuitry operating in accordance with software or otherwise embodied in hardware or a combination of hardware and software. For example, the processor 302 operating under software control, or the processor 302 embodied as an ASIC or FPGA specifically configured to perform the operations described herein, or a combination thereof, thereby configures the apparatus or circuitry to perform the functions of the transceiver. The transceiver may be configured to receive images. In an embodiment, the images correspond to a scene. In an embodiment, the transceiver may be configured to receive the scene information associated with the scene.

These components (302-306) may communicate with each other via a centralized circuit system 308 for capturing of image and/or video content. The centralized circuit system 308 may be various devices configured to, among other things, provide or enable communication between the components (302-306) of the apparatus 300. In certain embodiments, the centralized circuit system 308 may be a central printed circuit board (PCB) such as a motherboard, main board, system board, or logic board. The centralized circuit system 308 may also, or alternatively, include other printed circuit assemblies (PCAs) or communication channel media.

In an example embodiment, the processor 302 is configured to, with the content of the memory 304, and optionally with other components described herein, to cause the apparatus 300 to perform image rendering for an image associated with a scene. In an example embodiment, the scene may be a real-world scene. For example, the scene may depict a street-view of real-world location. In another example embodiment, the scene may represent a recreational park from a real-world location. Various other real-world locations may be represented by the scene of the image without limiting the scope of the disclosure.

In an example embodiment, the processor 302 is configured to, with the content of the memory 304, and optionally with other components described herein, to cause the apparatus 300 to access a scene information associated with one or more objects of the scene. In an embodiment, the scene information may include a projected panorama image associated with the scene. As described herein, the term ‘panorama image’ refers to images associated with a wider or elongated field of view. A panorama image may include a two-dimensional construction of a three-dimensional scene. In some embodiments, the panorama image may provide about 360 degrees view of the scene. The panorama image may be generated by capturing a video footage or multiple still images of the scene, as a multimedia capturing device (for example, a camera) is spanned through a range of angles. In an embodiment, the panorama image comprises a 2-D representation of 3-D objects in on a 2-D plane. In an embodiment, the projected panorama image may be configured as a background of the image of the scene being rendered by the apparatus 300.

In an embodiment, the apparatus 300 is configured to access the scene information from a geo-spatial sever, for example, NAVTEQ. In an embodiment, the server 108 of FIG. 1 may be an example of the geo-spatial sever. In an embodiment, the apparatus 300 is configured to process and transform the scene information received from the geo-spatial server to a format that may be suitably rendered by a client. In an example embodiment, the client may be web-browser. In an embodiment, the scene information may be transformed into a scene geometry data.

In an example, the scene geometry data may be utilized for rendering the scene on the display device. In an embodiment, the scene geometry data may also include a set of masks that correspond to image objects, a set of POI placements relative to the plurality of objects such as buildings and terrain associated with the scene. In an example embodiment, the processor 302 is configured to, with the content of the memory 304, and optionally with other components described herein, to cause the apparatus 300 to render the scene based on a scene geometry data. In an embodiment, the scene geometry may include an interactive 3-D geometry for facilitating an interaction with the one or more objects of the scene. For example, the scene geometry may allow a user to navigate between various objects such as buildings and point-of-interest in the rendered scene.

In an example embodiment, the processor 302 is configured to, with the content of the memory 304, and optionally with other components described herein, to cause the apparatus 300 to receive a request for inclusion of a first object in the scene comprising one or more second objects. In an embodiment, the first object may be a virtual object. In an embodiment, the virtual object may be a 3-D graphic object that may be interactively positioned and/or at one or more arbitrary positions in scene geometry comprising a 3-D panorama image. In an embodiment, the positioning of the may have to be performed in a manner that the virtual object may not occlude the visibility of other objects of the scene. For example, a virtual object such as a statue may be included in a scene depicting a garden. In this case, the virtual object may be included in the panorama image of the scene such that the inclusion of the virtual object may not substantially prevent the visibility of the any other object, particularly those objects that are closer to a reference location. In an embodiment, the reference location may be the location of a user observing the scene.

In an example embodiment, the processor 302 is configured to, with the content of the memory 304, and optionally with other components described herein, to cause the apparatus 300 to determine at least one second object of the one of more second objects being occluded by at least a portion of the virtual object based on the scene geometry data. In an example embodiment, the at least one second object being occluded by at least the portion of the virtual object may be determined by accessing the scene geometry data associated with the one or more second objects of the scene. The scene geometry data may provide distances between the one or more second objects and the reference location, and between the virtual object and the reference location. In an embodiment, based on the information associated with the relative distances, it may be determined whether the placement of the virtual object is father or closer to the reference location. In an embodiment, on determining that the placement of the virtual object is closer to the reference location, the at least one second object of the scene that may be occluded by at least a portion of the virtual object may be determined.

In an example embodiment, the processor 302 is configured to, with the content of the memory 304, and optionally with other components described herein, to cause the apparatus 300 to re-render the at least one second object being occluded by at least the portion of the virtual object in the scene based on the determination. In an embodiment, the re-rendering facilitates in preventing occlusion of the at least one second object by at least the portion of the virtual object. In an embodiment, re-rendering of the scene comprises rendering those second objects again in the panorama image that may have been occluded by the inclusion of the virtual object in the scene. For example, upon including a virtual object such as a statue in a scene of a garden, at least a portion of the image of the statue may be occluded due to the objects such as trees that are closer from a reference location, such as a user location than the virtual object. In such a case, the portions of the trees that are preventing the visibility of the portion of the statue may be re-rendered in the scene.

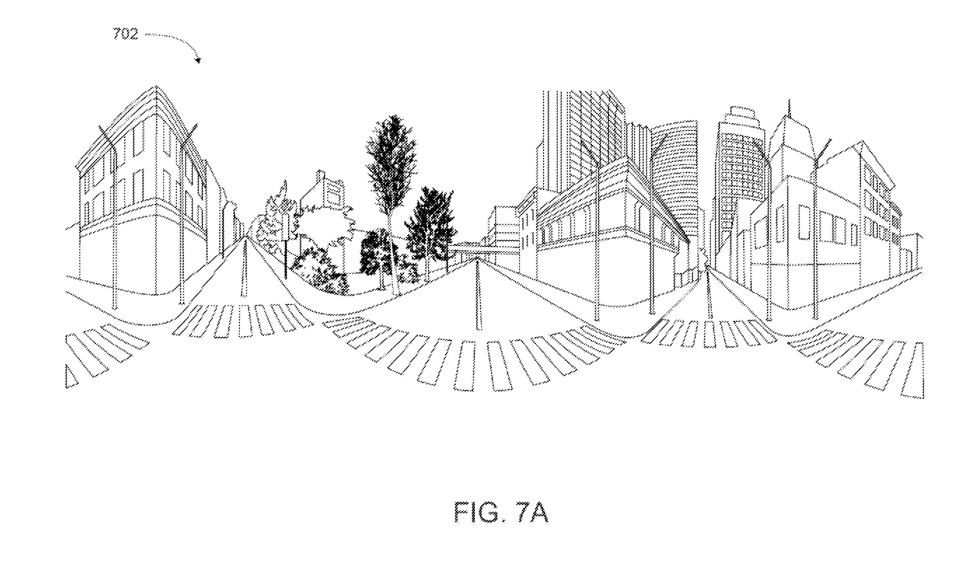

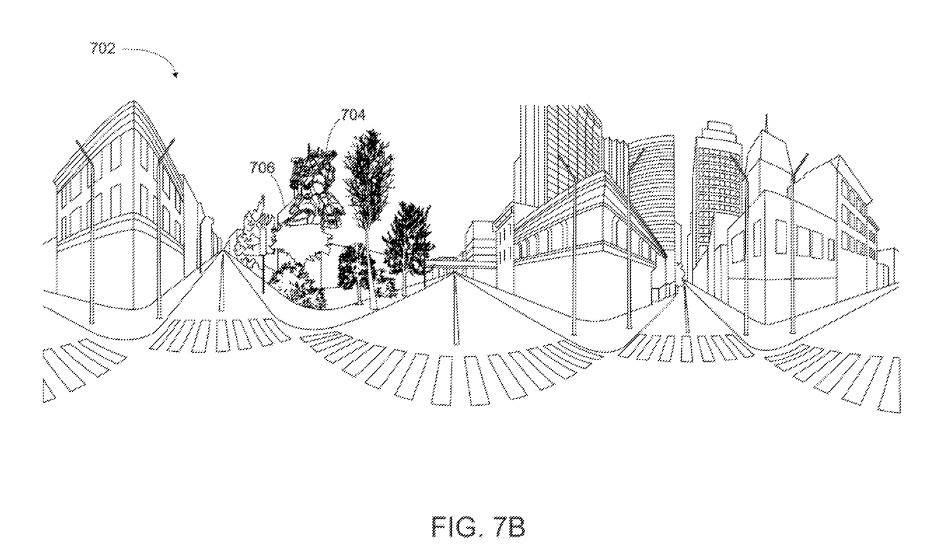

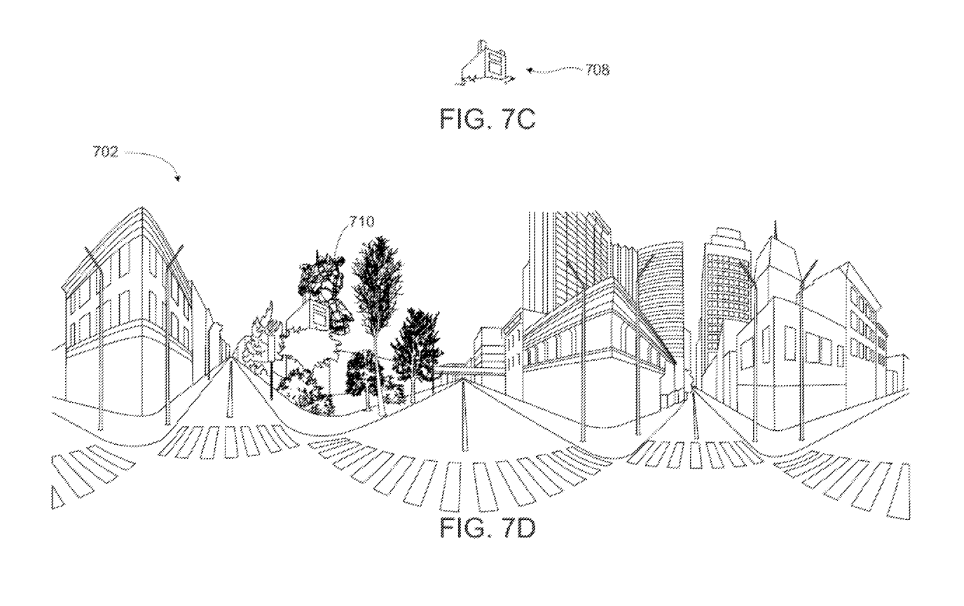

In an embodiment, re-rendering the at least one second object in the scene comprises determining a clipping path associated with the at least one second object. In an embodiment, the re-rendered objects may form a foreground portion of the re-rendered scene while the portion of the scene which is already rendered, may form a background portion of the scene. In an embodiment, the rendering and re-rendering of the scene may be performed based on the scene geometry data. For example, the scene information may include information regarding mask of the one or more second objects of the scene which may be utilized for determining a clipping path of the portions of second objects being occluded by the inclusion of the virtual object. The re-rendering of the scene geometry based on the scene geometry data is explained further with an example embodiment in detail in FIG. 7D.

In an example embodiment, a processing means may be configured to: receive a request for inclusion of a first object in a scene, the scene comprising one or more second objects; generate the scene based on a spatial information associated with the scene; render the scene based on a scene geometry data; determine at least one second object from the one or more second object being occluded by a portion of the first object based on the scene geometry data; and re-render the at least one second object being occluded by at least the portion of the first object in the scene based on the determination, wherein re-rendering facilitates in preventing occlusion of the at least one second object by at least the portion of the first object. An example of the processing means may include the processor 302, which may be an example of the controller 208.

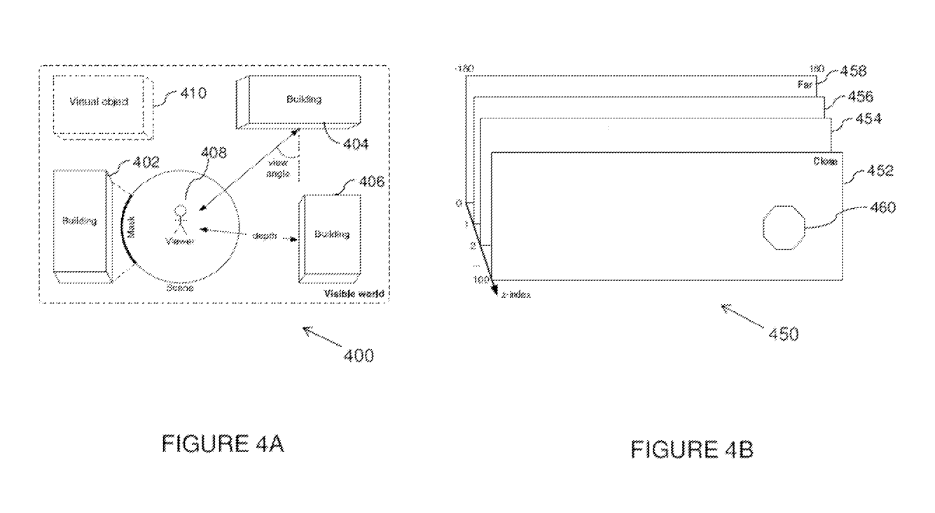

FIGS. 4A and 4B represent example scene and example scene geometry data associated with a scene, in accordance with an example embodiment. As illustrated, FIG. 4A represents a real-world scene 400. The scene may depict objects such as buildings, street, clouds and the like. For example, the scene 400 depicts buildings 402, 404, 406. In an embodiment, the scene may be seen from a reference location. In an embodiment, the reference location may be a location of a viewer. In an embodiment, one or more second objects of the scene may appear differently when viewed from different reference locations. For example, as illustrated in FIG. 4A, when a viewer is at location 408, various objects such as building 402, 404, 406 may appear to the viewer at a certain view angle and a certain depth. However, when the reference location is changed from the location 408 to any other location of the scene, the distance of the one or more second objects (such as buildings of the scene) and the view angle of the one or more second objects of the scene from the reference location is changed.

In an embodiment, a first object, for example, a virtual object such as a virtual object 410 may be included in the scene. In an embodiment, the virtual object may be included in a manner that due to presence of the one or more second object of the scene (such as buildings) that are closer to the point of view than the virtual object, certain portions of the virtual object may not be visible or become occluded. In an example embodiment, while rendering the scene, the virtual object may be rendered in a manner that the objects closer to the reference location relative to the virtual object may occlude the portions of virtual object that are restricting the visibility of the closer objects.

In an embodiment, occlusion culling may be performed for the virtual object that may be occluding the at least one second object of the scene appear closer than the virtual object when the scene and the virtual object are viewed from the reference location. As used herein, ‘occlusion culling’ refers to identifying and rendering only those portions of an image that may be visible, for example, from a user location. Occlusion culling is performed to limit the rendering of occluded objects in the image. For example, upon including a virtual object such as a statue in a scene of a garden, at least a portion of the image of the statue may be occluded due to the objects such as trees that are closer as compared to the virtual object when seen/observed from a user location or a point of view. In such a case, the portions of the statue that are being occluded may be occlusion culled, and prevented from being rendered. A representation illustrating rendering of the scene in accordance with an example embodiment is illustrated and explained with reference to FIG. 4B.

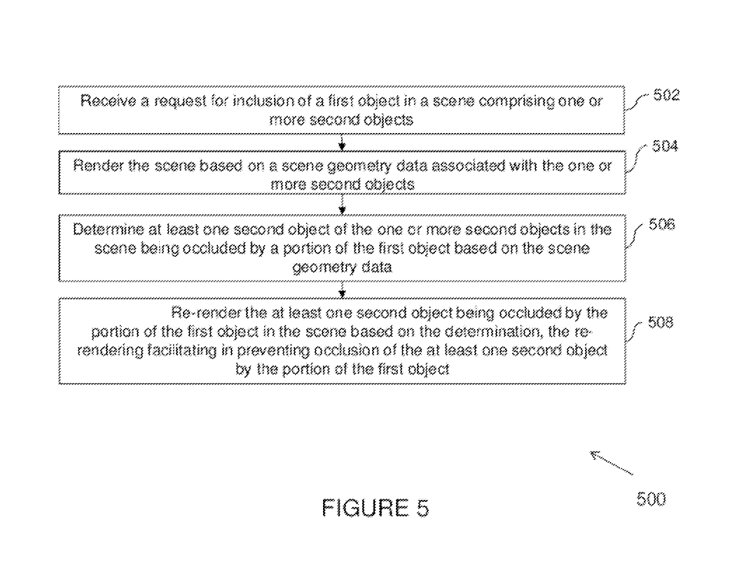

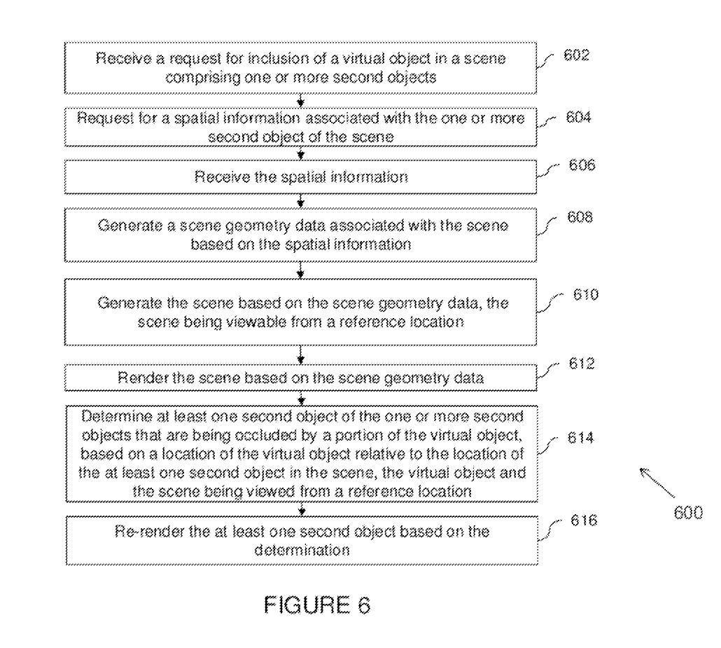

Referring to FIG. 4B, a scene 450 associated with a scene such as the scene 400 is illustrated. The scene 450 comprises a plurality of planes, such as planes 452, 454, 456, 458. In an embodiment, the plurality of planes 452, 454, 456, 458 positioned parallel to each other along an axis, for example z-axis, may be associated with at least one object of the scene. In an embodiment, the parallel planes comprising a respective object may be positioned based on a depth of an object, a distance of the point of interest with respect to the reference location, and the like. In an embodiment, the parallel planes includes a point-of-interest or an object mask associated with the scene being placed at various planes. In an embodiment, the objects located farther as compared to the virtual object from the point of reference may be rendered to thereby form a background of the rendered scene. For example, the plane 458 may include a projected panorama image of the scene. Various other planes comprising the masks of the objects may be overlaid on the plane comprising the background panorama image based on the depth associated with the respective objects, distance of the point of interest and the like. For example, the objects associated with the plane 452, for example, an object 460 are located closer to the reference location than the objects associated with the planes 452, 454, and the like. In an embodiment, the scene geometry data may be utilized for rendering the 3-D image of the scene. Some methods for rendering images, for example 3-D image of a scene are described further in detail with reference to FIGS. 5 and 6.

FIG. 5 is a flowchart depicting an example method 500 for rendering images, in accordance with an example embodiment. The method 500 depicted in the flow chart may be executed by, for example, the apparatus 300 of FIG. 3. In some embodiments, the rendered image comprises a virtual object inserted into the image. In an example embodiment, the process of rendering may be performed at a node, for example, a client, a server, or a client-server system. In an embodiment, the scene comprises one or more objects. For example, the scene may correspond to a street view of a city. The one or more objects may be buildings, complexes, tress and the like in the scene.

At block 502, the method 500 includes receiving a request for inclusion of a first object in a scene associated with a scene. In an embodiment, the scene may be a real-world scene associated with a real-world location. In an example embodiment, the first object may be a virtual object that may be positioned at any location in the scene. In an embodiment, on insertion of the virtual object, at least one second object of the scene may be occluded. For example, a virtual object may be included in a scene comprising a street view, then the virtual object may occlude a building or a tree that otherwise may be closer to the reference location relative to the location of the virtual object from the reference location.

At block 504, the method 500 includes rendering the scene. In an embodiment, the scene may be rendered in a manner such that the scene is viewable from the reference location. In an embodiment, the reference location may be changed while interacting with the scene. In an embodiment, the scene may be a rendered in a 3-D geometry. In an example embodiment, the scene may include an interactive geometry and facilitate interaction with the one or more second objects of the scene. For example, the scene may allow a user to pan between the second objects and point-of-interests of the scene. In an embodiment, the reference location may be point of view from where the user may be observing the scene. In an example embodiment, rendering the scene may include displaying the scene geometry on a display device, such as a display 216 of apparatus 200 (FIG. 2).

In an embodiment, prior to rendering the scene, the scene may be generated based on a scene geometry data. In an embodiment, the scene geometry data may include at least a projected panorama image of the scene. In an embodiment, the projected image of the scene may provide a 3-D image that may facilitate interaction with the one or more second objects of the scene. In an embodiment, the scene geometry data may further include a set of masks corresponding to the one or more second objects, and a set of points-of-interest (POI) placements relative to the one or more second objects. In an embodiment, the scene geometry data may be received from a server, for example a server 102 (FIG. 1).

At block 506, the method 500 includes determining at least one second object from the one or more second objects being occluded by at least a portion of the virtual object based on the scene geometry data. For example, one or more buildings or at least a portion thereof that may be occluded due to the inclusion of the virtual may be determined. In an example embodiment, the at least one second object being occluded by at least the portion of the virtual object may be determined by accessing the scene geometry data associated with the one or more second objects of the scene. The scene geometry data may provide distances between the one or more second objects and the reference location; and distance between the virtual object and the reference location. In an embodiment, based on the information associated with the relative distances, it may be determined whether the virtual object is father or closer than the one or more second objects of the scene when the scene and the virtual object are observed from the reference location. In an embodiment, on determining that the placement of the virtual object is closer to the reference location than that of at least one second object of the one or more second objects, the at least one second object of the scene that may occluded by at least a portion of the virtual object may be determined. For example, on inclusion of the virtual object in a scene representing a street view, the virtual object may occlude a building and/or a tree.

At block 508, the method includes re-rendering the at least one second object being occluded by at least a portion of the virtual object in the scene based on the determination. In an embodiment, the rendering of the at least one second object being occluded by at least a portion of the virtual object may be performed based on the scene geometry data. For example, the scene geometry data may provide a mask of the at least one second object. In an example embodiment, the mask may provide a clipping path associated with the at least one second object. The clipping path may be utilized for rendering the at least one second in the scene. The re-rendering of the one or more objects being occluded by the virtual path is explained in detail in conjunction with an example embodiment in FIGS. 7A-7D.

As disclosed herein with reference to FIG. 5, the method for rendering an image and inclusion of a virtual object therein may be performed at a client. In an embodiment, the client may be a web-browser. In an example embodiment, the method may be performed at a device comprising a server component and a client component such that the server component may facilitate in generation of the scene geometry data, and the client component may render the scene based on the scene geometry data.

In an example embodiment, a processing means may be configured to perform some or all of: receiving a request for inclusion of a first object in a scene, the scene comprising a one or more second objects; rendering the scene based on a scene geometry data, the scene geometry data being generated based on the scene information; determining at least one second object of the one or more second objects being occluded by a portion of the first object in the scene based on the scene geometry data; and re-rendering the at least one second object being occluded by the portion of the first object in the scene based on the determination, the re-rendering facilitating in preventing occlusion of the at least one second object by the portion of the first object.

FIG. 6 is a flowchart depicting an example method 600 for rendering of images in accordance with an example embodiment. The method 600 depicted in flow chart may be executed by, for example, the apparatus 300 of FIG. 3. Operations of the flowchart, and combinations of operation in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the method 600 are described with help of apparatus 300 of FIG. 3. However, the operations of the method can be described and/or practiced by using any other apparatus.

The method 600 may provide steps for generating and rendering of images of scenes. In an embodiment, the scene may be associated with a real-world location. For example, the scene may include a street-view of a real world location, an entertainment park, a residential complex location in a suburb, and the like. In an example embodiment, the scene may include or comprise one or more second objects. For example, a scene of an entertainment park may include a one or more second objects such as swings, water-pool, buildings such as castles, resorts, and the like.

At block 602 of method 600, a request for inclusion of a first object in a scene is received. In an embodiment, the first object is a virtual object. In an embodiment, the virtual object may include a 3-D image of any object that may be inserted in the scene. In an embodiment, the scene may be viewable from a reference location, for example a user location. In an example embodiment, the first object may be positioned or inserted at any location in the scene. In an embodiment, on insertion of the virtual object, at least one second object of the scene may be occluded in the scene. For example, a virtual object may be positioned in a scene of a recreational park such that the virtual object may occlude a building or a water-pool that otherwise may be closer to the reference location relative to the distance of the virtual object from the reference location. In an embodiment, the request may be made or generated at a device, for example, the device 200 by at least one ‘client’ and is processed by a ‘processor’.

In an embodiment, the client may be a web browser. In an embodiment, the request for inclusion of the virtual object may be processed by utilizing a spatial information associated with the scene. In an embodiment, the spatial information may provide a location information, an information associated with relative position of the one or more second objects of the scene, and the like. At block 604, a request for the spatial information associated with the scene is generated. In an embodiment, the spatial information associated with the scene may be received at a node configured to receive and process the spatial information. In an example embodiment, the spatial information may be generated at a server component.

At block 606, the spatial information associated with the scene is received. In an embodiment, the spatial information may be received at the server component. In an embodiment, the spatial information may be received from a geo-spatial server, for example, NAVTEQ. At block 608, a scene geometry data associated with the scene is generated based on the spatial information. In an embodiment, generation of the scene geometry data may be performed at a node configured to process the scene information. In an embodiment, the node configured to process the scene geometry data may be the server, for example, the server 102. In an embodiment, the node configured to process the scene information may be configured in a device, for example the device 200. In an embodiment, the scene geometry data may include at least one of a projected panorama image of the scene, a set of masks corresponding to the one or more second objects, and set of POI placements relative to the plurality of objects. In an embodiment, the scene information may be processed to generate the scene geometry data in a manner that the scene geometry data may be generated in a renderable-format.

At block 610, the scene may be generated based on the scene geometry data. In an embodiment, the scene may include an interactive 3-D geometry. In an embodiment, the interactive 3-D scene geometry facilitate an interaction with the one or more second objects of the scene. In an embodiment, the generated scene may be viewable from the reference location. In an embodiment, the reference location may be a location of a user. For example, the user may define a location in the scene location and may pan in the scene, and thus the distance of the reference location from various objects of the scene may vary based on the reference location.

At block 612, the scene may be rendered based on the scene geometry data. In an embodiment, rendering the scene may include displaying the scene on a display device, for example, a display 216 of the device 200. In an embodiment, rendering of the scene may be performed by a client, for example, a web browser, that may be configured to receive the scene geometry data, and render the scene based on the same.

At block 614, at least one second object of the one or more second objects that are being occluded by a portion of the virtual object are determined based at least on a location of the virtual object relative to the reference location in the scene. For example, one or more buildings or at least a portion thereof that may be occluded due to the inclusion of the virtual object in a scene depicting a recreational park may be determined. In an example embodiment, the one or more objects being occluded by the portion of the virtual object may be determined by accessing the scene geometry data associated with the one or more second objects of the scene. The scene geometry data may provide distances between the one or more second objects and the respective reference location; and distance between the one or more second objects and the reference location. In an embodiment, based on the information associated with the relative distances, it may be determined whether the placement of the virtual object is father or closer to the reference location as compared to the distance of the one or more second objects from the reference location. In an embodiment, it may be determined that the distance of the virtual object from the reference location is greater than the distance of at least one second object of the one or more second objects from the reference location. In an embodiment, on determining that the placement of the virtual object is farther than the at least one second object of the scene when viewed from the reference location, the at least one second object occluded by the portion of the virtual object may be determined. For example, on inclusion of the virtual object in a scene representing a street view, the virtual object may occlude at least one second object such as a building and/or a tree.

At block 616, the method 600 includes re-rendering the at least one second object being occluded by the portion of the virtual object based on the determination. In an embodiment, the re-rendering of the at least one second object being occluded by the portion of the virtual object may be performed based on the scene geometry data. For example, the scene geometry data may provide a mask of the at least one second object. In an example embodiment, the mask may provide a clipping path associated with the at least one second objects. The clipping path may be utilized for re-rendering the portion of the virtual object in the scene. The re-rendering of the at least one second object being occluded by the virtual object is explained in detail in conjunction with an example embodiment in FIGS. 7A-7D.

To facilitate discussion of the methods 500 and/or 600 of FIGS. 5 and 6, certain operations are described herein as constituting distinct steps performed in a certain order. Such implementations are exemplary and non-limiting. Certain operation may be grouped together and performed in a single operation, and certain operations can be performed in an order that differs from the order employed in the examples set forth herein. Moreover, certain operations of the methods 500 and/or 600 are performed in an automated fashion. These operations involve substantially no interaction with the user. Other operations of the methods 500 and/or 600 may be performed by in a manual fashion or semi-automatic fashion. These operations involve interaction with the user via one or more user interface presentations.

FIGS. 7A, 7B 7C and 7D illustrate representation of a method for rendering images, in accordance with an example embodiment. For example, in FIG. 7A, a scene 702 rendered on a client device is illustrated. The scene comprises a street view of a real-world location. In an embodiment, the scene may be generated based on spatial information received from a server, for example, a geo-spatial server. In an embodiment, the scene may comprise a projected image of the scene that may form a background image of the scene. In an embodiment, the projected image of the scene may provide a 3-D image of the scene that may facilitate interaction with the one or more second objects of the scene. In an embodiment, the 3-D image of the scene may be a panorama image, for example, as illustrated in FIG. 7A.

Referring now to FIG. 7B, a virtual object, for example, a virtual object 704 is included in the scene 702 (of FIG. 7A). In an embodiment, the virtual object 704 may be a 3-D representation of a real-world object or an illusionary object. In an embodiment, the inclusion of the virtual object in the scene may occlude or restrict the visibility of at least one second object of the scene that are otherwise closer to a reference location or a viewing location of a user as compared to the location of the virtual object when viewed from the same reference location. For example, in the present embodiment, the building 706 is occluded due to the insertion of the virtual object in the scene 702. However, as determined by the scene geometry data, the building 706 is otherwise closer than the virtual object 704, from the reference location. In order to render the scene properly, a portion of the virtual object occluding the objects (such as the building) of the scene may be culled.

In an example, a mask of the at least one second object that is being occluded by the virtual object may be obtained from the scene geometry data, and the mask may be utilized for re-rendering the at least one second object in the scene by performing occlusion culling of the portion of the virtual object that is farther as compared to the at least one second object of the scene when viewed from a reference location. For example, in the present embodiment, the mask corresponding to image of the building 706 being occluded by the virtual object 704 may be determined based on the scene geometry data. In an embodiment, the mask of the building may represent a clipping path for the occluded at least one second object. In an example embodiment, the following code may be represent an example clipping path metadata for the building:

```
“Building”: [{
  “URL”: “http://navteq-maps.ovi.com.edgesuite.net/3/buildings/
  658377494.zip”,
  “LocationId”: “24193869”,
  “Name”: “n/a”,
  “Visibility”: 0.35440000891685486,
  “Masks”: [“114,31 114,48 133,47 133,27 123,25”],
  “Facades”: [{
    “points”: 187,
    “depth”: 112.849,
    “degree”: 63.4486,
    “_id”: “4f945726ae0a572f6a000223”,
    “placement”: {
      “y”: 37.0481,
      “x”: 118.797
    }
}, ...]
```

In an embodiment, based on the clipping path, a clipped image 708 may be generated, for example, as illustrated in FIG. 7C. In the present example embodiment, the image of the at least one second object, for example, the building 706 that is occluded by the virtual object, and then clipped by using the scene geometry data may be re-rendered. For example, FIG. 7D illustrates the clipped portion of the building 706 being re-rendered in the scene 702 such that the portion of the virtual object 704 that is farther as compared to the building 706, when seen from the reference location, is occluded by the re-rendered portion of the building 706.

Without in any way limiting the scope, interpretation, or application of the claims appearing below, a technical effect of one or more of the example embodiments disclosed herein is to perform rendering of image associated with a scene. As explained in FIGS. 2-7D, the scene may be real-world scenes, for example, those associated with a real-world location. In an embodiment, the embodiments disclosed herein provides methods and device for inclusion of objects, such as virtual objects in the real-word scene without occluding a visibility of closer objects of the scene. In various embodiment, the disclosed devices may be configured to perform rendering without a need of hardware graphics accelerators. The disclosed devices may include a rendering engine based on, for example, HTML canvas 2D context, for performing occlusion culling on virtual objects inserted into the scenes. In an embodiment, the rendering engine may retrieve data, for example, scene geometry data for performing rendering processes (for example, painting, such as imagery, paths, clipping, and the like) from geo-data services (e.g. NAVTEQ). In various embodiments, the disclosed rendering engine allows devices with limited graphic acceleration capabilities to run augmented and mirror world applications. Moreover, the disclosed methods and apparatus are compatible with lower network bandwidth as well since no 3D model of the objects associated with the scene are required at the client for performing occlusion culling.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 2 and/or 3. A computer-readable medium may comprise a computer-readable storage medium that may be any media or means that can contain or store the instructions for use by or in connection with an instruction execution system, apparatus, or device, such as a computer. In one example embodiment, the computer readable medium may be non-transitory.

If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications, which may be made without departing from the scope of the present disclosure as defined in the appended claims.

1-58. (canceled)

59. A method comprising:
receiving a request for inclusion of a first object in a scene comprising one or more second objects;
rendering the scene based on a scene geometry data associated with the one or more second objects;
determining at least one second object of the one or more second objects in the scene being occluded by a portion of the first object based on the scene geometry data; and
re-rendering the at least one second object being occluded by the portion of the first object in the scene based on the determination, the re-rendering facilitating in preventing occlusion of the at least one second object by the portion of the first object.

60. The method as claimed in claim 59, further comprising generating the scene based on the scene geometry data.

61. The method as claimed in claim 59, wherein the scene geometry data comprises at least one of a projected panorama image of the scene, a set of masks corresponding to the one or more second objects, and a set of points-of-interest (POI) placements relative to the one or more second objects.

62. The method as claimed in claim 59, wherein determining comprises:
accessing the scene geometry data associated with the one or more second objects of the scene; and
determining distances of the at least one second object and the first object from the reference location based on the scene geometry data.

63. The method as claimed in claim 59, further comprising receiving spatial information associated with the scene.

64. The method as claimed in claim 63, further comprising determining the scene geometry data based on the spatial information associated with the scene.

65. The method as claimed in claim 59, further comprising rendering the scene.

66. The method as claimed in claim 59, wherein the scene comprises an interactive geometry for facilitating an interaction with the one or more second objects of the scene.

67. An apparatus comprising:
at least one processor; and
at least one memory comprising computer program code, the at least one memory and the computer program code configured to, with the at least one processor, cause the apparatus to at least perform:
receive a request for inclusion of a first object in a scene comprising one or more second objects;
generate the scene based on a spatial information associated with the one or more second objects of the scene;
render the scene based on a scene geometry data, the scene geometry data being generated based on the scene information;
determine at least one second object of the one or more second object in the scene being occluded by a portion of the first object based on the scene geometry data; and
re-render the at least one second object being occluded by the portion of the first object in the scene based on the determination, the re-rendering facilitating in preventing occlusion of the at least one second object by the portion of the first object.

68. The apparatus as claimed in claim 67, wherein the scene geometry data comprises at least one of a projected panorama image of the scene, a set of masks corresponding to the one or more second objects, and a set of points-of-interest (POI) placements relative to the one or more second objects.

69. The apparatus as claimed in claim 67, wherein the apparatus is further caused, at least in part, to:
access the scene geometry data associated with the one or more second objects of the scene; and
determine distances of the at least one second object and the first object from the reference location based on the scene geometry data.

70. The apparatus as claimed in claim 67, wherein the apparatus is further caused, at least in part, to receive the spatial information at a server component of the apparatus.

71. The apparatus as claimed in claim 67, wherein the apparatus is further caused, at least in part, to receive the spatial information from a geo-spatial server.

72. The apparatus as claimed in claim 67, wherein the apparatus is further caused, at least in part, to render the scene at a client component of the apparatus.

73. The apparatus as claimed in claim 68, wherein the scene comprises an interactive geometry for facilitating an interaction with the one or more second objects of the scene.

74. A computer program product comprising at least one computer-readable storage medium, the computer-readable storage medium comprising a set of instructions, which, when executed by one or more processors, cause an apparatus to at least perform:
receive a request for inclusion of a first object in a scene comprising one or more second objects;
render the scene based on a scene geometry data associated with the one or more second objects;
determine at least one second object of the one or more second objects in the scene being occluded by a portion of the first object based on the scene geometry data; and
re-render the at least one second object being occluded by the portion of the first object in the scene based on the determination, the re-rendering facilitating in preventing occlusion of the at least one second object by the portion of the first object.

75. The computer program product as claimed in claim 74, wherein the apparatus is further caused, at least in part, to generate the scene based on the scene geometry data.

76. The computer program product as claimed in claim 74, wherein the scene geometry data comprises at least one of a projected panorama image of the scene, a set of masks corresponding to the one or more second objects, and a set of points-of-interest (POI) placements relative to the one or more second objects.

77. The computer program product as claimed in claim 74, wherein the apparatus is further caused, at least in part, to:
access the scene geometry data associated with the one or more second objects of the scene; and
determine distances of the at least one second object and the first object from the reference location based on the scene geometry data.

78. An apparatus comprising:
at least one processor; and
at least one memory comprising computer program code, the at least one memory and the computer program code configured to, with the at least one processor, cause the apparatus to at least perform:
receive a spatial information associated with a scene, the scene comprising one or more second objects; and
generate a scene geometry data based on the spatial information, the scene geometry data configured to facilitate in determination of at least one second object of the one or more second objects in the scene being occluded by a portion of a first object included into the scene.
